(19) United States
(12) Patent Application Publication
(10) Pub. No.: US 2006/0059423 A1
(43) Pub. Date: Mar. 16, 2006

(54) Apparatus, system, and method for creating customized workflow documentation

(76) Inventors: Stefan Lehmann, Tucson, AZ (US); Brad Alan Schweitzer, Tucson, AZ (US)

Correspondence Address: KUNZLER & ASSOCIATES, 8 EAST BROADWAY, SUITE 600, SALT LAKE CITY, UT, 84111, US

(21) Appl. No.: 10/939,577

(22) Filed: Sep. 13, 2004

(51) Int. Cl. G06F 17/24; G06F 17/21; G06F 17/00

(52) U.S. Cl. 715/530; 715/500

(57) ABSTRACT

An apparatus, system, and method are provided for creating customized workflow documentation. The apparatus includes an interface module, a-content module, and an assembly module. The interface module gathers input from a user regarding the workflow to be documented. The content module gathers the required pre-defined content sections for the workflow to be documented. The assembly module creates a single document containing the pre-defined content sections in an ordered, comprehensive, contiguous document that is available as an electronic copy or hard copy.

### BACKGROUND OF THE INVENTION

1. Field of the Invention

The invention relates to technical documentation. Specifically, the invention relates to apparatus, systems, and methods for creating customized workflow documentation.

2. Description of the Related Art

Completing a particular task can typically be broken down into a set of procedures. Methodically following these procedures ensures that the task is completed properly. Based on circumstances surrounding the task, decisions may need to be made while completing the task that affect which procedure is performed next. The process of completing a task by following procedures and making decisions about the next procedure to be executed based on specific circumstances is often called a workflow. Workflows are used for a variety of business and domestic tasks. Workflows are particularly useful when working with computer systems.

Systems typically include one or more devices designed to work together to produce a result. Generally, systems require an operator to perform maintenance tasks regularly to keep the system working properly. In particular, computer systems require maintenance tasks that may include hardware and software upgrades. Workflows are commonly designed for each maintenance task to ensure that the operator properly performs the task.

These workflows describe the actions that must be taken to perform a particular task. Generally, the workflows provide step-by-step instructions intended to guide an operator through the task. A workflow may have several branch points at which the step-by-step instructions change depending on the configuration of the system.

A branch point generally presents the user with decisions to be made. For example, a workflow for installing software on a computer may present the decision—“If a previous version of this software is installed on the computer please uninstall the previous version before inserting the CD-ROM. If a previous version of this software is not installed on the computer, then insert the CDROM.” The next step in this example workflow for installing software, depends on the response to the decision. These decisions may also be referred to as conditional statements because a condition is presented and the circumstances determine which step(s) will follow. The workflow branches due to the conditional statement.

In this example, one branch, or set of procedures, of the workflow is to uninstall the previous version of the software. The other branch is to insert the CD-ROM. Branch points are common in workflows, especially in workflows for completing computer system maintenance tasks.

Computer systems consist of one or more hardware devices, software installed on the hardware devices, and networks that connect the hardware devices. The configuration of a computer system describes the hardware devices in the system, the version of each hardware device, and the version of software installed on each hardware device. The configuration also describes the networks or buses that connect the hardware devices to each other. Typical maintenance tasks for computer systems include changing the configuration of the system by upgrading hardware, upgrading software, monitoring resources, such as disk space and memory, and monitoring log files.

Writing technical documentation or workflow instructions that accurately guide an operator through a maintenance task is challenging due to the wide range of possible configurations that a particular computer system may have. The documentation must provide workflow instructions that account for each potential system configuration. For example, two computer systems, each consisting of a host computer and an external tape drive, may have identical configurations except for the model number of the external tape drive. A different workflow to upgrade the software on the tape drive exists for each system. Workflow documentation must be created for each system that provides step-by-step instructions for completing the upgrade. Many procedures of the upgrade may be common between the two workflows. The workflow documentation should present the instructions for both systems in such a manner that the instructions are not confusing to the reader.

Conventional workflow documents handle a plurality of configurations by providing workflow documents that include branch points similar to the example described above. An operator using these workflow documents begins with the first procedure and continues sequentially through the workflow procedures until a branch is encountered.

For example, the workflow document may read “If you are using tape drive model 773 then perform steps 1 through 6 on page 10, if you are using tape drive model 873 then perform steps 1 through 6 on page 22.” Branches in the workflow document can confuse the operator and can lead to errors in performing the maintenance task. This style of workflow documentation is common, and is used for various types of workflows, not just those associated with computer systems.

FIG. 1 illustrates an example workflow document 100 written to assist an operator performing a firmware upgrade for a computer tape drive. The workflow document 100 indicates that the operator has to jump between various pages of the workflow document 100. The operator may follow a path in which they are to perform procedures on page 4, on page 217, on page 7, then back on page 217. In this case, the workflow document 100 is not contiguous. The set of procedures that the operator must follow are not consecutively listed in the document 100, instead they are spread throughout the document 100.

Workflow documents that are not contiguous can be problematic for operators. An operator could easily perform the procedure on page 4, skip over or ignore the instruction telling them to go to page 217, and instead perform the procedure on page 5. Performing the wrong procedure, or a procedure in an improper order can be a costly mistake due to lost time due to recovery time required. In addition, the computer system is now in a state that is likely not covered in the workflow documentation 100.

In order to recover, the operator may need to contact support personnel for the computer system to get a live diagnosis and instructions on how to recover from the error. Such support calls are expensive and avoidable if the operator had followed the instructions correctly.

The challenges in properly following a workflow document 100 are often more pronounced in complex computer systems. Workflow documentation for complex computer systems is often spread among a plurality of documents contained within a plurality of volumes. Performing a maintenance task with a workflow document 100 spread out among a plurality of volumes requires that the operator have access to all of the relevant documents at once. Such access may be problematic because the documents may be shared among a group of operators. Certain volumes may be unavailable at any one time. In addition, it is difficult to know which volumes will be needed ahead of time. Furthermore, moving between several volumes can be time consuming and confusing.

In performing a maintenance task the workflow often requires the operator to repeat a series of procedures. As shown in FIG. 1, step 4 of the upgrade repeats step 2. The same procedure, B, C, or D, needs to be repeated in step 4 even though the procedure was previously completed in step 2.

In order to perform the step, the operator must turn to the appropriate page (i.e., page 6 for procedure B) in order to locate the procedure. The workflow requires an operator to accurately find the correct procedure, execute the procedure, and return to the correct location in the manual in order to get the next step. Requiring an operator to jump around within a document can lead to errors because they may get lost and perform a similar, but incorrect, procedure.

An additional drawback of conventional workflow documents is that the operator performing the maintenance task must have knowledge of the system configuration or learn the configuration prior to following the workflow documentation. If the operator does not know the system configuration well enough to answer the questions posed in the workflow document, the workflow cannot be followed or is followed inefficiently. For example, the operator performing the upgrade may not know the version of tape drive and may have to learn the version before starting or continuing the workflow.

In response to the problems of conventional workflow documentation, software documentation wizards have been developed. Generally, a wizard is software the operator installs on a host computer of the system. The wizard typically inspects the current configuration of the computer system directly. Consequently, the operator does not need to provide answers to any configuration questions. The documentation wizard determines the system configuration by scanning various files on the devices of the system. Documentation wizards provide workflow instructions to the operator electronically by displaying step-by-step instructions on the monitor of the host computer. These documentation wizards do not provide a printed workflow document, but rather guide the operator through the process electronically.

The documentation wizard approach is not well suited for sophisticated systems consisting of many components. In such systems, relying on the operator to view electronic documentation through the duration of the maintenance task is not realistic since the computer system displaying the documentation can be off-line during many steps of the maintenance task. If the system is off-line, the operator is left without any instructions, since the operator can not view the electronic documentation of the documentation wizard. In order to perform maintenance tasks for sophisticated systems, the operator should have accurate workflow documentation available during the duration of the task.

Additionally certain documentation wizards require that the computer system have access to a network in order to retrieve content for the workflow documentation. Such access is impractical if a task requires the computer system to be off-line during the task. Accordingly, workflow documentation will not be available to an operator during the duration of the task.

Software wizards are also typically operating system dependent, limiting their use to a particular operating system. Software wizards often use hyperlinks to enable the user to jump from section to section. The use of hyperlinks is more convenient than having to manually jump around in a document, but hyperlinks are confusing to users since the user cannot follow a single, contiguous workflow document. Hyperlinks also fail to present the content in a contiguous manner such that previous steps can be readily reviewed as needed. Additionally, software wizards typically do not provide a checklist allowing the user to mark progress through a workflow.

From the foregoing discussion, it should be apparent that a need exists for an apparatus, system, and method that generates workflow documentation that is comprehensive, contiguous, and ordered, and that is available in a hard copy version so that the user can follow the hard copy version when the system is on or off-line. Beneficially, such an apparatus, system, and method would save the user time and reduce the number of errors during the maintenance task caused by jumping between sections of documentation.

### SUMMARY OF THE INVENTION

The present invention has been developed in response to the present state of the art, and in particular, in response to the problems and needs in the art that have not yet been met for providing comprehensive, ordered, and contiguous workflow documentation for maintenance tasks. Accordingly, the present invention has been developed to provide an apparatus, system, and method for creating customized workflow documentation that overcomes many or all of the above-discussed shortcomings in the art.

An apparatus according to the present invention includes an interface module, a content module, and an assembly module. The interface module collects configuration information about a system for which a workflow is to be documented. Preferably, the interface module comprises a script or other types of instructions, such as HTML or plug-in software configured for execution in a web browser such as Microsoft® Internet Explorer. The content module retrieves pre-defined content sections required to document the workflow from a content repository. The assembly module assembles the pre-defined content sections retrieved by the content module into a customized workflow document.

Preferably, the resulting customized workflow document is a comprehensive document containing all necessary pre-defined content sections required cat to perform the workflow within a single document. The customized workflow document is preferably ordered such that instructions are presented sequentially, in the order in which they should be performed according to the workflow. The customized workflow document is preferably contiguous so that an operator performing a workflow can proceed through the document sequentially, with pre-defined content sections describing sequential procedures located contiguous to each other within the document.

In certain embodiments, the apparatus includes a print module that enables printing a hard copy of the customized workflow document. The hard copy enables performance of the workflow when an electronic copy is not available. A checklist may be included in the customized workflow document that allows the user to mark progress through the workflow.

In certain embodiments, the apparatus includes a stand-alone content repository. The stand-alone content repository allows the apparatus to operate on a single computer without network access. Preferably, the stand-alone content repository comprises a persistent storage device such as a disk storage device.

In certain embodiments, the apparatus generates customized workflow documentation in a plurality of formats. The documentation formats include markup language formats, such as Hypertext Markup Language (HTML) or eXtensible Markup Language (XML), word processing formats, such as Microsoft Word, multi-media formats, such as Macromedia Flash and electronic publishing formats such as Portable Document Format (PDF).

A method of the present invention is also presented for creating customized workflow documentation. In one embodiment, the method includes collecting configuration information from a user. Next, one or more pre-defined content sections are retrieved based on the configuration information. The pre-defined content sections are assembled into a customized workflow document and presented to the user.

The present invention also includes embodiments arranged as a system, alternative apparatus, additional method steps, and machine-readable instructions that comprise substantially the same functionality as the components and steps described above in relation to the apparatus and method. The present invention provides a generic customized workflow documentation solution that provides comprehensive, ordered, contiguous documentation in a number of formats. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a conventional example of a tape drive upgrade workflow document;

FIG. 2 is a schematic block diagram illustrating one embodiment of a system in accordance with the present invention;

FIG. 3 is a schematic flow chart diagram illustrating the procedures of a sample workflow;

FIG. 4A is a schematic block diagram illustrating a user interface for one embodiment of a system in accordance with the present invention;

FIG. 4B is a schematic block diagram illustrating a workflow document produced by one embodiment of the present invention;

FIG. 5 is a schematic flow chart diagram illustrating one embodiment of a method for creating customized workflow documentation; and

FIG. 6 is a schematic block diagram illustrating one embodiment of a system in accordance with the present invention.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

While examples of customized documentation are described herein for workflow tasks related to computer maintenance, those of skill in the art will recognize that the present invention may be used for various workflows that include conditional branching.

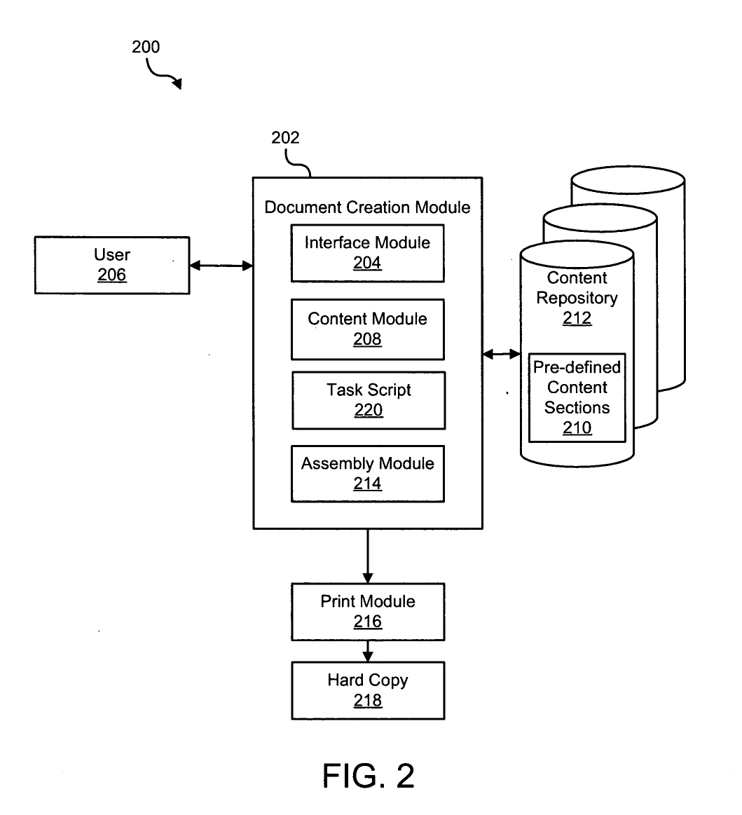

FIG. 2 illustrates one embodiment of a system 200 for creating customized workflow documentation. A document creation module 202 includes an interface module 204 that collects configuration information from a user 206. Based on the configuration information that the interface module 204 provides, a content module 208 follows a task script 220 to determine which pre-defined content sections 210 the customized workflow documentation requires. The content module 208 then retrieves a set of pre-defined content sections 210 from a content repository 212. The content module 208 provides the retrieved content sections 210 to an assembly module 214. The assembly module 214 arranges the pre-defined content sections 210 in the correct order to create a customized workflow document. In one embodiment, the interface module 204 presents the customized workflow document directly to the user 206 as an electronic copy. Alternatively, a print module 216 creates a hard copy 218 of the customized workflow document.

In the depicted embodiment, the interface module 204 comprises instructions, such as a script, HTML or plug-in software that a web browser, such as Microsoft® Internet Explorer, executes. The interface module 204 presents questions to the user 206 that determine the maintenance task to be performed and the configuration, including the hardware and software versions, of the system on which the maintenance task is to be performed. In one embodiment, the interface module 204 examines to system to gather certain configuration information.

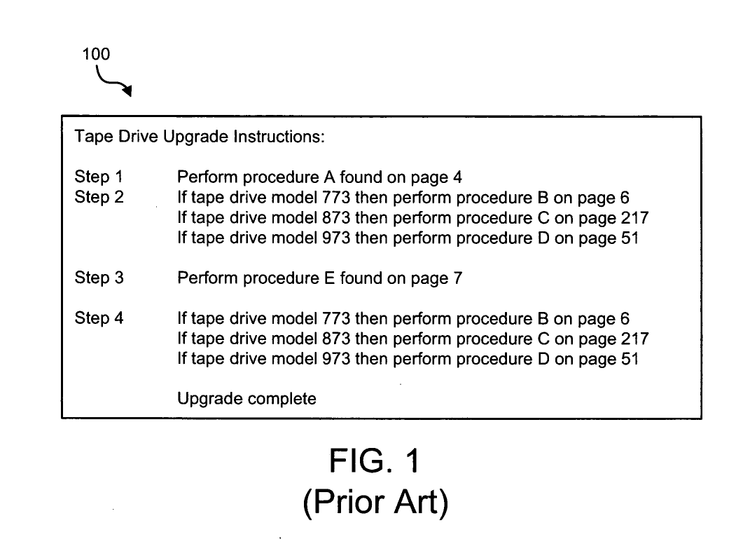

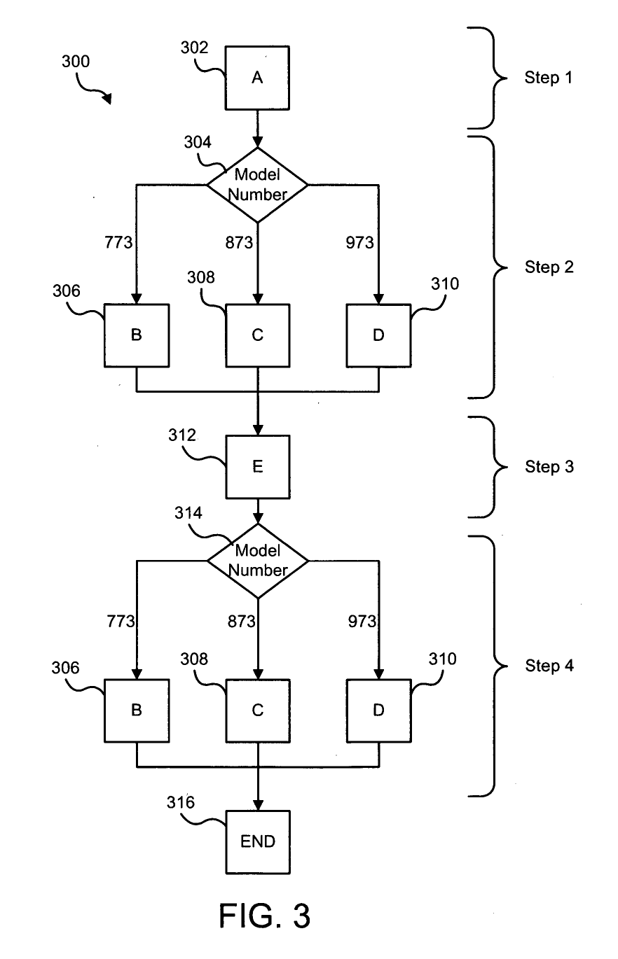

FIG. 3 is a workflow flowchart 300 illustrating an example maintenance task of performing a tape drive upgrade. The workflow flowchart 300 is a graphical representation of a set of procedures and decisions representing one or more workflows resulting from one or more system configurations. The workflow flowchart 300 includes three different workflows, one for each of three different models of tape drives, models 773, 873, and 973. The workflow flowchart 300 illustrates the procedures and decisions listed in the workflow document 100 illustrated in FIG. 1.

First, an operator performs 302 procedure A. It will be noted that procedure A is performed regardless of the model of tape drive being upgraded. Next, a determination 304 is made based on the model number of the tape drive being upgraded. If the tape drive is model 773 then procedure B 306 is performed. Procedure C 308 is performed if the tape drive is model 873, and procedure D 310 is performed if the tape drive model is 973.

The operator performs procedure E 312 regardless of the tape drive model. Next, a determination 314 is made again based on the tape drive model number. The operator performs procedure B 306 for model 773, procedure C 308 for model 873, and procedure D 310 for model 973. Note that these procedures 306,308,310 are identical to the procedures following a determination 304 that the operator performed earlier in the workflow. Repetition of certain procedures may be typical of a workflow for a computer system. For example, a diagnostic procedure may be conducted before and after making a significant modification. Once procedure B 306, C 308, or D 310 is complete, the tape drive upgrade is finished 316.

Certain procedures of the workflow, i.e. procedures A 302 and E 312, are performed regardless of the tape drive model. Other procedures, B 306, C 308, and D 310, are selectively performed based on configuration information such as the model number of the tape drive. Workflow flowcharts 300, similar to the one shown in FIG. 3, illustrate one or more workflows. The number of decision points in the workflow flow chart 300 is related to the number of workflows represented by the workflow flowchart 300. Typically, the operator executes one of the workflows illustrated by the workflow flowchart 300. The operator's system configuration determines which one of the workflows illustrated by the workflow flowchart 300 the operator will execute.

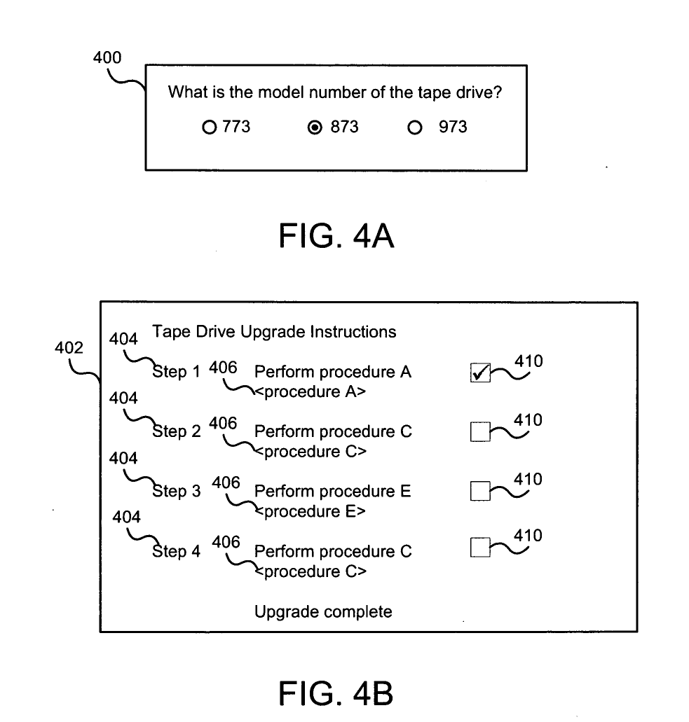

FIG. 4A illustrates a graphical user interface 400 for collecting user input for creating customized workflow documentation. The graphical user interface 400 may enable the operator to select which one of the three workflows illustrated in the workflow flowchart 300 should be documented in a workflow document. The graphical user interface 400 prompts a user for the model number of the tape drive to be upgraded. Of course, the graphical user interface 400 may include a plurality of prompts. In this example, one prompt is shown for clarity. Based on the user input, the present invention creates a customized workflow document 402 illustrated in FIG. 4B.

The customized workflow document 402 is comprehensive since the document 402 contains just the content sections 406 necessary for the workflow in a single document 402. The document 402 may be ordered with each step 404 in the workflow arranged and numbered consecutively. Preferably, the document 402 may be contiguous with each content section 406 placed adjacent to the proper preceding content section. The content section 406 for Procedure C 308 is included in the document 402 in step 2 and again in step 4. Instead of requiring the user to reference a different section of the document 402 repeatedly with intermediate steps, the content section 406 for procedure C 308 is repeated. In this manner, a user may follow the workflow in a top-down, sequential manner. Repeating the content-sections 406 and automatically integrating content sections that depend on configuration information eliminates the need for the user to jump anywhere else in the documentation 402 or to any other volume.

Unlike a conventional workflow document 100 illustrated in FIG. 1, the customized workflow document 402 does not present questions to the user within the workflow document 402. The workflow document 402 does not require the user to make any decisions along the way. Such information is collected at one time, before the workflow document 402 is presented. The user then views the customized workflow document 402 electronically or generates a hard copy. The user simply performs the workflow step 404 by step 404 according to the customized workflow document 402.

The user may concentrate on following the workflow without having to answer questions. Providing user input up front allows a skilled user to answer configuration questions, generate the customized workflow document 402 and then handoff the document 402 to a less skilled technician for execution. Current workflow documents prevent this approach since configuration questions must be answered throughout the workflow. Additionally, checkboxes 410 may be provided to enable the user to mark progress through the workflow.

A different workflow document may be created depending on the user's responses to the configuration question(s) in the graphical user interface 400. In the illustrated embodiment, since there are three possible answers to the configuration question, three corresponding workflow documents 402 may be produced. Conventional workflow documents handle multiple different user configurations by using branching within the workflow documentation, as discussed above. The resulting jumping around is disruptive and confusing to the user. The customized workflow document 402 eliminates branching by documenting the workflow according to a particular configuration or circumstance.

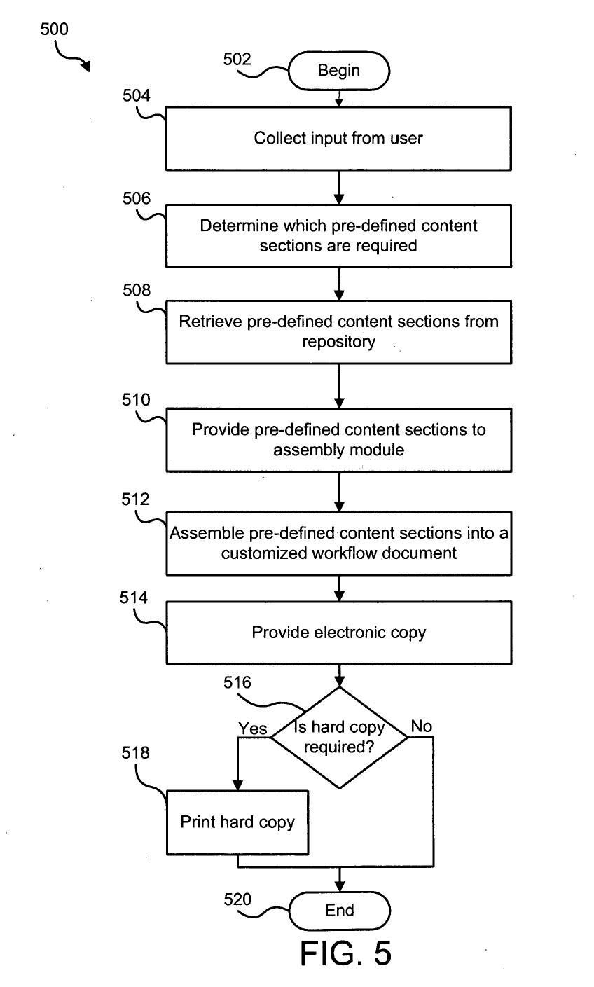

FIG. 5 illustrates a schematic flow chart diagram illustrating one embodiment of a method 500 for creating a customized workflow document. The method 500 begins 502 when the interface module 204 collects 504 user input including the maintenance task to be performed and system configuration information. The interface module 204 may follow the task script 220 to determine the configuration questions to be presented to the user. Based on the user input, the content module 208 determines 506 the procedures required for the customized workflow document 402.

The content module 208 determines which procedures the customized workflow document 402 requires by following a set of instructions referred to as a task script 220. The task script 220 comprises decision statements and procedure statements for a maintenance task. The task script 220 may be written using any conventional programming or scripting language.

Each decision statement specifies one or more procedures to be followed for each outcome of the decision. The outcome of the decision statement typically depends on system configuration information. For example, a decision statement may be: “If tape drive model 773 then perform procedure B”.

Procedure statements in the task script 220 specify a procedure to be performed. The procedure is typically performed regardless of system configuration information. For example, a procedure statement may be: “Perform procedure E”. The task script 200 comprises a plurality of decision statements and a plurality of procedure statements arranged in a predetermined order that represents the steps of a maintenance task.

Each task script 220 typically represents one maintenance task. The maintenance task may comprise more than one workflow as discussed above in relation to FIG. 3. The workflow flowchart 300 illustrated in FIG. 3 is a graphical representation of a task script 220.

The content module 208 processes the decision statements of the task script 200 using information gathered by the interface module 204. The result of executing the task script 220 is an ordered set of procedures required for the customized workflow document 402.

Next, the content module 208 creates a list of the pre-defined content sections 210 corresponding to the ordered set of procedures required for the customized workflow document 402. Each pre-defined content section 210 may be marked with a tag. The tag maps the pre-defined content section 210 to a procedure. The tag enables the content module 208 to convert the ordered set of procedures required for the customized workflow document 402 to an ordered set of pre-defined content sections 210. The content module 208 then communicates with the content repository 212 to retrieve 508 the required pre-defined content sections 210 from the repository 212 and provides 510 them to the assembly module 214.

Pre-defined content sections 210 are portions of content that are used to create a final workflow document 402. The sections 210 typically are not a complete document that would be useful on their own, instead they are a series of steps that perform a particular procedure which can be fit into a final customized workflow document 402. The content sections 210 are pre-defined; they are created prior to being placed in the content repository 212. In one embodiment, the pre-defined content sections 210 may be created dynamically.

The pre-defined content sections 210 may comprise text, for example a set of instructions or descriptions, pictures, illustrations, audio, video, and the like. Each pre-defined content section 210 is stored in any format suitable for that type of content in the content repository 212. Some types of content, such as audio and video, cannot be printed in a hardcopy of the customized workflow document 402, but may be played back in an electronic implementation of the customized workflow document 402.

The content repository 212 provides a storage location for all pre-defined content sections 210. In one embodiment, the content repository 212 and document creation module 202 are located on a single computer. In this manner, the content repository 210 is stand-alone and the entire method 500 of creating customized workflow documentation can be executed using a single computer. In another embodiment, the document creation module 202 is located on one computer and the content repository 212 is located on a different hardware device, such as a one or more data storage devices.

The assembly module 214 assembles 512 the pre-defined content sections 210 in the correct order. The assembly module 214 determines the order of the pre-defined content sections 210 by following the ordered set of procedures produced by the content module 208. In one embodiment, the assembly module 214 then creates a single customized workflow document 402 consisting of each of the pre-defined content sections 210 arranged in the correct order.

In one embodiment the customized workflow document 402 that the assembly module 214 produces may be in any of the following formats: a markup language format, such as Hypertext Markup Language (HTML) or eXtensible Markup Language (XML), a word processing format such as Microsoft Word, a multi-media format such as Macromedia Flash, an electronic publishing format such as Portable Document Format (PDF), or the like.

The document creation module 202 may provide 514 an electronic copy of the customized workflow document 402 to the user 206. In one embodiment, the user 206 determines 516 if a hard copy 218 version of the document 402 is required. Alternatively, the document creation module 202 may determine from the task script 220 that a hard copy 218 version is needed. If a hard copy 218 version is needed the print module 216 prints 518 the hard copy 218 version and the method 500 ends 520.

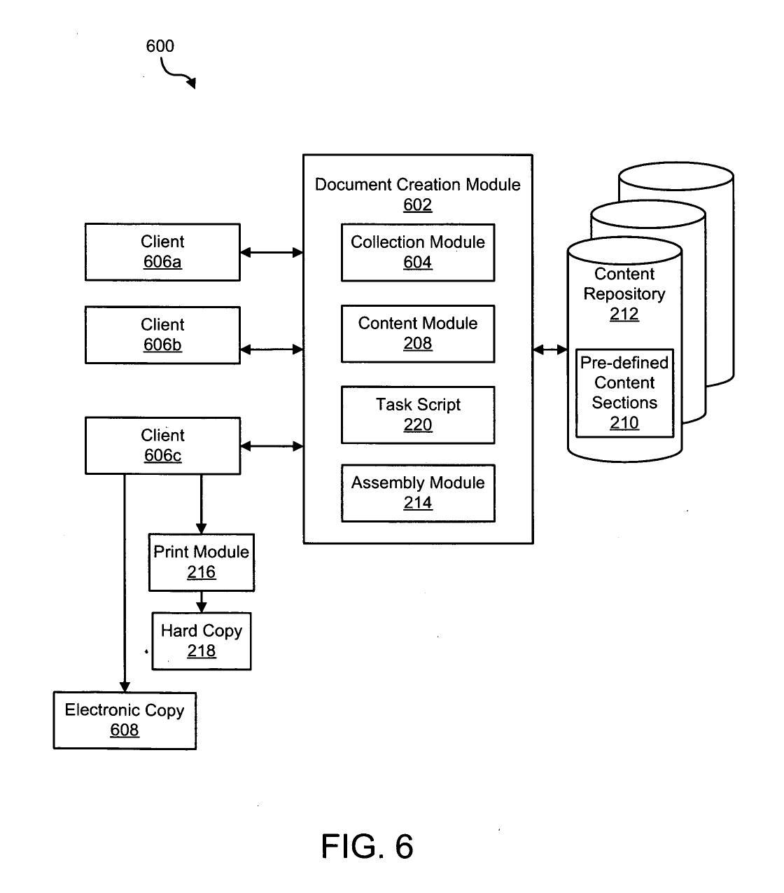

FIG. 6 illustrates another embodiment of a system 600 for creating customized workflow documentation. The system 600 includes a content repository 212 storing pre-defined content sections 210, a content module 208, a task script 220 an assembly module 214, and a print module 216 that operate in substantially the same manner as those described in relation to FIG. 2.

The system 600 also includes a document creation module 602 that comprises the content module 208, the assembly module 214, and a collection module 604. The collection module 604 collects configuration information from one or more clients 606a-c. The configuration information may be automatically collected or manually entered by a user.

In one embodiment, the document creation module 602 operates on a central computer system such as a server, mainframe, or the like in communication with the clients 606a-c. Each client 606a-c may be installed on a different computer and configured to share the single document creation module 602. In certain embodiments, the client 606a-c comprise stand-alone client software programs or plug-in software that a web browser such as Microsoft Internet Explorer can execute. The client 606a-c may read and follow the task script 220 in order to present questions to the user 206 to determine the maintenance task to be performed and the configuration, including the hardware and software versions, of the system on which the maintenance task is to be performed.

The collection module 604 provides user input, including configuration information and the maintenance task to be performed, to the content module 208. The content module 208 retrieves the appropriate content sections 210 from the content repository 212 by following the task script 220 in substantially the same manner as described in relation to FIG. 2. The assembly module 214 assembles the retrieved content sections 210 into a customized workflow document 402. The document creation module 602 provides the customized workflow document 402 to the client 606a-c. If a hard copy 218 of the customized workflow document 402 is required, the client 606a-cmay send the customized workflow document 402 to the print module 216. The print module 216 produces a hard copy 218 of the customized workflow document 402. The document creation module 602 may also produce an electronic copy 608 of the customized workflow document 402 that is sent to a client 606a-c for display to the user 206.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for creating customized workflow documentation, the apparatus comprising:
an interface module configured to collect configuration information from a user;
a content module configured to retrieve one or more pre-defined content sections based on the configuration information; and
an assembly module configured to assemble the pre-defined content sections into a customized workflow document.

2. The apparatus of claim 1 wherein the customized workflow document comprises a single comprehensive document that provides instructions required to perform a desired workflow.

3. The apparatus of claim 1 wherein the customized workflow document comprises an ordered set of instructions required to perform a desired workflow.

4. The apparatus of claim 1 wherein the customized workflow document comprises a contiguous set of instructions required to perform a desired workflow.

5. The apparatus of claim 1 further comprising a print module configured to print a hard copy version of the customized workflow document.

6. The apparatus of claim 1 wherein the content module reads pre-defined content sections from a stand-alone content repository.

7. The apparatus of claim 1 wherein the assembly module generates the customized workflow document in a format selected from the group consisting of markup language format, word processing format, multi-media format, and electronic publishing format.

8. The apparatus of claim 1 wherein the interface module further comprises a web browser.

9. An apparatus for creating customized workflow documentation, the apparatus comprising:
a collection module configured to receive configuration information from one or more clients;
a content module configured to retrieve one or more pre-defined content sections based on the configuration information; and
an assembly module configured to assemble the pre-defined content sections into a customized workflow document.

10. The apparatus of claim 9 wherein the customized workflow document comprises a single comprehensive document that provides instructions required to perform a desired workflow.

11. The apparatus of claim 9 wherein the customized workflow document comprises an ordered set of instructions required to perform a desired workflow.

12. The apparatus of claim 9 wherein the customized workflow document comprises a contiguous set of instructions required to perform a desired workflow.

13. The apparatus of claim 9 wherein the assembly module generates the customized workflow document in a format selected from the group consisting of markup language format, word processing format, multi-media format, and electronic publishing format.

14. A system to provide customized workflow documentation, the system comprising:
one or more storage devices each containing one or more pre-defined content sections;
a document creation module comprising
an interface module configured to collect configuration information from a user;
a content module configured to retrieve one or more pre-defined content sections based on the configuration information; and
an assembly module configured to assemble the pre-defined content sections into a customized workflow document.

15. The system of claim 14 wherein the customized workflow document comprises a single comprehensive document that provides instructions required to perform a desired workflow.

16. The system of claim 14 wherein the customized workflow document comprises an ordered set of instructions required to perform a desired workflow.

17. The system of claim 14 wherein the customized workflow document comprises a contiguous set of instructions required to perform a desired workflow.

18. The system of claim 14 further comprising a print module configured to print a hard copy version of the customized workflow document.

19. The system of claim 14 wherein retrieving the pre-defined content sections comprises reading pre-defined content sections from an off-line content repository.

20. The system of claim 14 wherein the customized workflow document is in a format selected from the group consisting of markup language format, word processing format, multi-media format, and electronic publishing format.

21. A method for creating customized workflow documentation, the method comprising:
collecting configuration information from a user;
retrieving one or more pre-defined content sections based on the configuration information; and
assembling the pre-defined content sections into a customized workflow document.

22. The method of claim 21 wherein the customized workflow document comprises a single comprehensive document that provides instructions required to perform a desired workflow.

23. The method of claim 21 wherein the customized workflow document comprises an ordered set of instructions required to perform a desired workflow.

24. The method of claim 21 wherein the customized workflow document comprises a contiguous set of instructions required to perform a desired workflow.

25. The method of claim 21 further comprising printing a hard copy version of the customized workflow document.

26. The method of claim 21 wherein retrieving the pre-defined content sections comprises reading pre-defined content sections from a stand-alone content repository.

27. The method of claim 21 wherein the customized workflow document is in a format selected from the group consisting of markup language format, word processing format, multi-media format, and electronic publishing format.

28. The method of claim 21 wherein the configuration information is collected using a web browser.

29. A signal bearing medium tangibly embodying a program of machine-readable instructions executable by a digital processing apparatus to perform operations to create customized workflow documentation, the operations comprising:
an operation to collect configuration information from a user;
an operation to retrieve one or more pre-defined content sections based on the configuration information; and
an operation to assemble the pre-defined content sections into a customized workflow document.

30. An apparatus for creating customized workflow documentation, the apparatus comprising:
a means for collecting configuration information from a user;
a means for retrieving one or more pre-defined content sections based on the configuration information; and
a means for assembling the pre-defined content sections into a customized workflow document.
